(19) United States
(12) Patent Application Publication
(10) Pub. No.: US 2017/0357785 A1
(43) Pub. Date: Dec. 14, 2017

(54) METHOD, APPARATUS AND SYSTEM FOR PROTECTING CONTENT BASED ON OPEN LICENCE

(71) Applicant: MARKANY INC., Seoul (KR)

(72) Inventors: Hyoungjun KIM, Seoul (KR); Kyusun CHO, Seoul (KR); Hongjoon HA, Seoul (KR); Jonguk CHOI, Seoul (KR)

(73) Assignee: MARKANY INC., Seoul (KR)

(21) Appl. No.: 15/623,338

(22) Filed: Jun. 14, 2017

(30) Foreign Application Priority Data
Jun. 14, 2016 (KR) 10-2016-0073781

(51) Int. Cl. G06F 21/10; H04L 9/08; G06F 21/16

(52) U.S. Cl. CPC G06F 21/105; H04L 9/0861; H04L 9/0894; G06F 2221/0724; G06F 21/16

(57) ABSTRACT

A method, apparatus and system for protecting content based on an open license is disclosed. The method for protecting content based on an open license performed by a content protecting device may include receiving content from a user terminal; selecting an open license corresponding to the received content; analyzing a plurality of license authority items corresponding to the selected open license; storing license data including a value of the plurality of license authority items which is analyzed in a database with being linked with a unique identifier of the content; generating a Digital Rights Management (DRM) authority matched to the open license based on the value of the plurality of license authority items which is analyzed; and requesting to encrypt the content based on the generated DRM authority to a DRM server. Accordingly, the copyright of the content can be easily protected.

### CROSS-REFERENCE TO RELATED APPLICATIONS

This application claims the benefit of priority of Korean Patent Application No. 10-2016-0073781, filed Jun. 14, 2016, which is incorporated by reference in its entirety herein.

### BACKGROUND OF THE INVENTION

### Field of the Invention

The present invention relates to a method, apparatus and system for protecting content based on an open license, and more particularly, to a method, apparatus and system for protecting content based on an open license which may protect content from an illegal use according to the authority that an author wants based on the open license of the content.

### Discussion of the Related Art

Generally, copyright may mean an exclusive and proprietary right for a work that expresses though and emotion of a person. The work may mean a creative work such as a book, a novel, a poem, a thesis, a lecture, a speech, a scenario, a music, a drama, a dance, a painting, a calligraphy, a design, a sculpture, a craft, a building, a picture, an image, a figure, a translation, a transcription, a computer program, and so on in which human creativity is included.

As an internet becomes popular, the public is able to access large amounts of information. Accordingly, search and browse for various digital works through the online is available, and the infringement of copyright becomes highly possible by the plagiarism of the works, illegal use, unapproved secondary elaboration, and the like. Particularly, recently, owing to the development of the three-dimensional printer and the printing technique, the copyright of the drawing for the three-dimensional printing has emerged as an important issue.

Accordingly, a system for protecting a copyright is required. Conventionally, it is recommended to utilize the Creative Commons License (CCL) for protecting the copyright and to obey the CCL regulation. The CCL is a kind of a standardized agreement and an expression of permission for using the copyright in which a copyright holder declares a method and a condition for using the work made by the copyright holder. That is, it can be said that the CCL corresponding to the work is the standardized license of the work.

Previously, a copyright holder selects a license item and category of the work that the copyright holder wants to protect among the standardized license items, and marks it on the work. And, after understanding the use method and the condition of permission for the work by identifying the license marked on the work, the users use the work accordingly.

However, according to the copyright protection scheme, there is a possibility of forgery and falsification in the CCL itself, and the work may be deformed or reprocessed, different from the intention of the copyright holder. Thus, a technique for preventing the forgery and falsification of the CCL of the work has been developed. For example, Korean patent publication 2012-0064548 discloses an apparatus for protecting the copyright of digital content that may prevent the forgery and falsification of a CCL by processing a CCL in a form of watermark and inserting the CCL into the content.

However, such conventional copyright protection schemes recommend for a user to obey the content advised by the CCL of a work only, but are not compelled to obey it, and accordingly, there is a problem that it is highly possible that a user infringe a copyright of a work intentionally or unintentionally. In addition, since the general content Digital Right Management (DRM) system restricts a content use based on the final distributor of the content, a problem occurs that there is a restriction in the secondary processing and the distribution activation that requires cooperation.

### SUMMARY OF THE INVENTION

An object of the present invention to solve the problem of described above is to provide a method, an apparatus and system for protecting content based on an open license which may protect the right of the content copyright holder reliably, by controlling the use authority of the content based on an open license selected by the content copyright holder.

An aspect of the present invention is to provide a method for protecting content based on an open license to attain the object. The method for protecting content based on an open license performed by a content protecting device may include receiving content from a user terminal; selecting an open license corresponding to the received content; analyzing a plurality of license authority items corresponding to the selected open license; storing license data including a value of the plurality of license authority items which is analyzed in a database with being linked with a unique identifier of the content; generating a Digital Rights Management (DRM) authority matched to the open license based on the value of the plurality of license authority items which is analyzed; and requesting to encrypt the content based on the generated DRM authority to a DRM server.

The step of selecting the open license may include: displaying an open license selecting user interface displaying open licenses applicable to the content on the user terminal; and selecting the open license designated by the user terminal through the open license selecting user interface.

The method for protecting content based on an open license may further include determining whether the received unique identifier of the content is detected from the content or metadata of the content; determining the content to be a primary content which is newly registered content, when a unique identifier of the content is not detected; and determining the content to be a secondary content which is re-registered content that has a history of being registered at least once, when the unique identifier of the content is detected.

The method for protecting content based on an open license may further include extracting pre-stored license data corresponding to the unique identifier of the content from the database before selecting the open license, when the content is the secondary registered content, and selecting the open license may include selecting the open license among open licenses permitted by the extracted license data.

The method for protecting content based on an open license may further include generating a unique identifier of the content; and inserting the unique identifier of the content in the content in a form of watermark or in the metadata of the content, when the content is the primary registered content.

The method for protecting content based on an open license may further include generating an encryption key for encrypting the content; and storing the encryption key in the database, and requesting to encrypt the content to the DRM server may include requesting the generated encryption key and an encryption request message including the DRM authority to the DRM server.

The open license may be a Creative Common License (CCL). For example, the open license may be one of BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), and BY-SA (show copyright holder-under the same condition, modification is allowed).

The open license may be one of PDD (Public Domain Dedication), GPL (General Public License), LGPL (Lesser General Public License), BSD (Berkeley Software Distribution) license, Apache license, AGPL (Affero General Public License), MIT license, Artistic license, and MPL (Mozilla Public License).

The plurality of license authority items may include: a first license authority item representing whether an author of content is displayed; a second license authority item representing whether content is commercially used and re-registration is prohibited; a third license authority item representing whether the content is a secondary work, editing and saving are prohibited; and a fourth license authority item representing whether license condition change is prohibited.

The step of generating the DRM authority matched to the open license may include configuring a value of a plurality of DRM authority items for controlling a use of the content based on the plurality of license authority items. The plurality of DRM authority items may include: a first DRM authority item representing whether the information of the author of the content is preserved when re-registering; a second DRM authority item representing whether the license condition change is allowed; a third DRM authority item representing whether the re-registration of the content is allowed; a fourth DRM authority item representing whether the commercial use of the content is allowed; a fifth DRM authority item representing whether the editing of the content is allowed; and a sixth DRM authority item representing whether the content is able to be saved.

Meanwhile, another aspect of the present invention is to provide an apparatus for protecting content based on an open license to attain the object. The apparatus for protecting content based on an open license may include a receiver configured to receive content from a user terminal; an open license selection unit configured to select an open license corresponding to the received content; a license analysis unit configured to analyze a plurality of license authority items corresponding to the selected open license; a license registration unit configured to store license data including a value of the plurality of license authority items which is analyzed in a database with being linked with a unique identifier of the content; a DRM authority generation unit configured to generate a Digital Rights Management (DRM) authority matched to the open license based on the value of the plurality of license authority items which is analyzed; and a DRM processing unit configured to request to encrypt the content based on the generated DRM authority to a DRM server.

The open license selection unit may display an open license selecting user interface displaying open licenses applicable to the content on the user terminal, and select the open license designated by the user terminal through the open license selecting user interface.

The apparatus for protecting content based on an open license may further include a determination unit configured to determine whether the received unique identifier of the content is detected from the content or metadata of the content, determine the content to be a primary content which is newly registered content, when a unique identifier of the content is not detected, and determine the content to be a secondary content which is re-registered content that has a history of being registered at least once, when the unique identifier of the content is detected.

When the content is the secondary registered content, the open license selection unit may extract pre-stored license data corresponding to the unique identifier of the content from the database before selecting the open license, and select the open license among open licenses permitted by the extracted license data.

For the case that the content is the primary registered content, the apparatus for protecting content based on an open license may further include a unique identifier generation unit configured to generate a unique identifier of the content; and a unique identifier insertion unit configured to insert the unique identifier of the content in the content in a form of watermark or in the metadata of the content.

The DRM processing unit may generate an encryption key for encrypting the content, store the encryption key in the database, and request the generated encryption key and an encryption request message including the DRM authority to the DRM server.

The open license may be a Creative Common License (CCL). For example, the open license may be one of BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), and BY-SA (show copyright holder-under the same condition, modification is allowed).

The open license may be one of PDD (Public Domain Dedication), GPL (General Public License), LGPL (Lesser General Public License), BSD (Berkeley Software Distribution) license, Apache license, AGPL (Affero General Public License), MIT license, Artistic license, and MPL (Mozilla Public License).

Meanwhile, still another aspect of the present invention is to provide a system for protecting content to attain the object. The system for protecting content may include a content protection unit configured to receive content from a first user terminal, select an open license corresponding to the received content, analyze a plurality of license authority items corresponding to the selected open license, store license data including a value of the plurality of license authority items which is analyzed in a database with being linked with a unique identifier of the content, and generate a Digital Rights Management (DRM) authority matched to the open license based on the value of the plurality of license authority items which is analyzed; a DRM server unit configured to encrypt the content based on the DRM authority and transmit the content to a content distribution unit; and a DRM license server unit configured to receive the DRM authority from the content protection unit, and generate a DRM license for a use of the content encrypted based on the DRM authority.

The content protection unit may display an open license selecting user interface displaying open licenses applicable to the content on the user terminal, and select the open license designated by the user terminal through the open license selecting user interface.

The content protection unit may determine whether the received unique identifier of the content is detected from the content or metadata of the content, determine the content to be a primary content which is newly registered content, when a unique identifier of the content is not detected, and determine the content to be a secondary content which is re-registered content that has a history of being registered at least once, when the unique identifier of the content is detected.

The content protection unit may extract pre-stored license data corresponding to the unique identifier of the content from the database before selecting the open license, and select the open license among open licenses permitted by the extracted license data, when the content is the secondary registered content.

The content protection unit may generate a unique identifier of the content; and a unique identifier insertion unit configured to insert the unique identifier of the content in the content in a form of watermark or in the metadata of the content, when the content is the primary registered content.

The content protection unit may generate an encryption key for encrypting the content, store the encryption key in the database, and request the generated encryption key and an encryption request message including the DRM authority to the DRM server.

The DRM server unit may encrypt the content using the encryption key and the DRM authority, and link metadata of the content with the content. The content distribution unit may distribute the encrypted content to a second user terminal, and the DRM license server unit may distribute the DRM license to the second user terminal. Then, by the DRM module provided in the second user terminal, a use of the content is controlled according to the DRM authority.

### BRIEF DESCRIPTION OF THE DRAWINGS

FIG. 1 is a block diagram illustrating a construction of a content protection system on the basis of implementing a method for protecting content according to a preferred embodiment of the present invention.

FIG. 2 is a block diagram illustrating detailed construction of the content protection unit shown in FIG. 1.

FIGS. 3 and 4 are flowcharts for description the entire operation flow of the content protection system. FIGS. 3 and 4 show continuous operations, but are divided for the convenience of description.

FIG. 5 is an exemplary diagram illustrating an open license selecting user interface displayed on the first user terminal by the open license generation unit.

FIG. 6 is an exemplary diagram illustrating an authority analysis table representing values of a license authority item and a DRM authority item that corresponds to an open license.

FIG. 7 is a flowchart for describing a part of operation of the content protection unit mainly in the case that a secondary content is received from the first user terminal.

FIG. 8 is a flowchart for describing the embodiment of selectively performing DRM application to the content registered according to a selected open license as another embodiment of the present invention.

### DETAILED DESCRIPTION OF THE INVENTION

The inventive subject matter now will be described more fully hereinafter with reference to the accompanying drawings, in which embodiments of the present invention are shown. However, the present invention may be embodied in many different forms, modifications, equivalents and alternatives, which are included in the inventive concept and scope, and should not be construed as limited to the embodiments set forth herein.

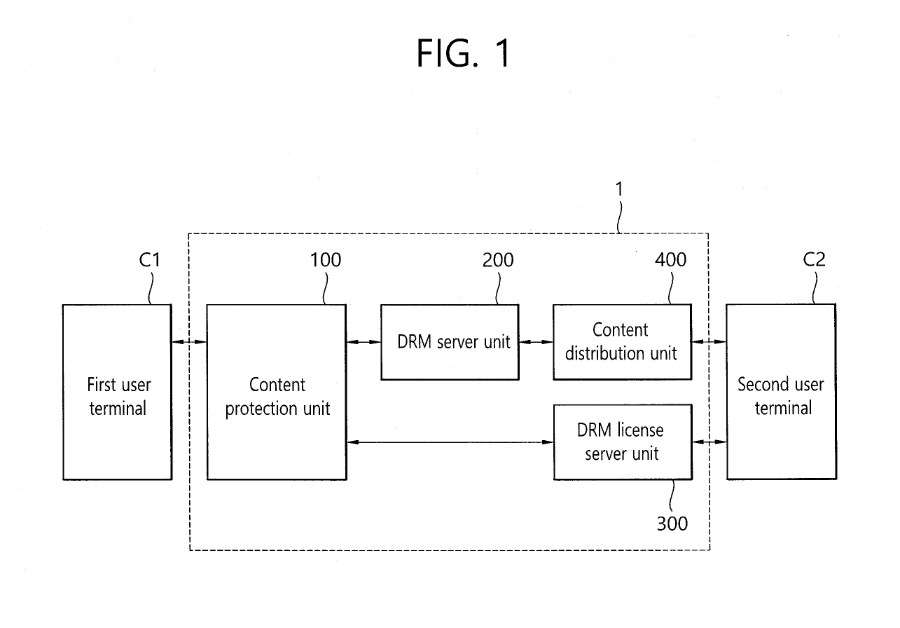

FIG. 1 is a block diagram illustrating a construction of a content protection system on the basis of implementing a method for protecting content according to a preferred embodiment of the present invention.

First, a content protection system 1 according to a preferred embodiment of the present invention may register content and license data based on an open license of the content that is available to be configured by a copyright holder, and may distribute the registered content by applying a Digital Rights Management (DRM) policy matched to the open license so as to be used within an allowed authority. Such a content protection system 1 may protect a right of the copyright holder strictly and reliably when the content of which copyright is required to be protected is distributed.

As shown in FIG. 1, the content protection system 1 may include a content protection unit 100, a DRM server unit 200, a content distribution unit 400, a DRM license server unit 300, and so on. Each of the units may be implemented by at least one computer terminal of a server grade in hardware. The computer terminal may include a memory configured to store a program including software commands, a processor configured to execute the program stored in the memory, an input output unit, and so on.

The content protection unit 100 is a subject of registering and managing content based on an open license, and may be implemented as a form of a Content Management System (CMS), for example. The content protection unit 100 may be linked with a first user terminal C1. The first user terminal C1 may mean a computer terminal of a first user. Herein, the computer terminal may be a wired or wireless network communication terminal such as a Personal Computer (PC), a notebook, a smart phone, a smart pad, and the like.

The first user is a person who is going to register the content in the content protection system 1 and to be protected by the copyright of the content when the content is distributed to other users. For example, the first user may be a copyright holder that produces the contents or a copyright holder that modifies content produced by other person within a permissible range. Herein, the content may be a 3D drawing, an image, a multimedia, a sound source, and so on.

The content protection unit 100 may register the content received from the first user terminal C1 based on an open license. For example, the content protection unit 100 may receive content from the first user terminal C1, select an open license corresponding to the received content, analyze a plurality of license authority items corresponding to the selected open license, and store license data including a value of the analyzed a plurality of the license authority items in a database with being linked with a unique identifier of the content, thereby registering the content in the content protection system 1.

In addition, the content protection unit 100 may generate information for applying the DRM based on an open license to the content, and may link it with the DRM server unit 200 and the DRM license server unit 300. For example, the content protection unit 100 may generate a DRM authority matched to the open license based on the value of the analyzed a plurality of the license authority items, and may request the DRM server unit 200 to encrypt the content based on the generated DRM authority. Meanwhile, the content protection unit 100 may transmit the generated DRM authority and the like to the DRM license server unit 300.

The DRM server unit 200 may encrypt the content using an encryption key and the DRM authority according to the request of the content protection unit 100, and may forward the encrypted content to the content distribution unit 400. The DRM license server unit 300 may generate and manage the DRM license linked with the encrypted content based on the information such as the DRM authority forwarded to the content protection unit 100.

The content distribution unit 400 may be a subject for distributing the content, and may be implemented as a form of a Content Distribution System (CDS), for example. The second user terminal C2 may request the content by accessing to the content distribution unit 400, and should receive the DRM license linked with the content from the DRM license server unit 300 in order to use the content.

The second user terminal C2 may be a computer terminal of a second user, for example, a Personal Computer (PC), a notebook, a smart phone, a smart pad, and the like. In the second user terminal C2, a DRM module may be installed for limiting the use of the content transmitted from the content distribution unit 400 according to the DRM license.

Hereinafter, the content protection method according to a preferred embodiment of the present invention will be described. By the description below, the operation, the function of each of the elements, the structure and the interworking process among the elements of the content protection system 1 will be more particularly and clearly described.

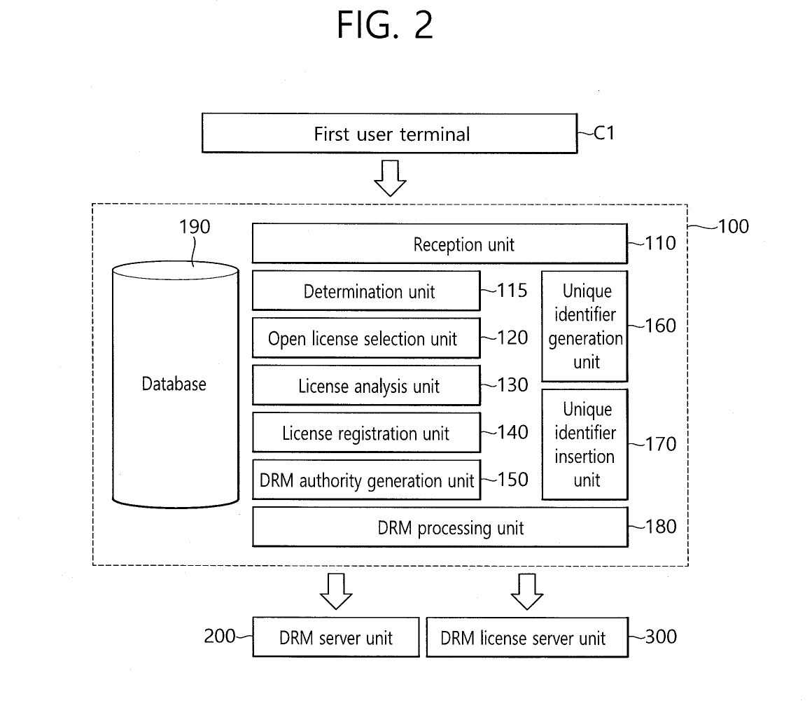

FIG. 2 is a block diagram illustrating detailed construction of the content protection unit 100 shown in FIG. 1, and shows a structure of the content protection apparatus according to a preferred embodiment of the present invention.

First, referring to FIG. 2, the content protection unit 100 may include a reception unit 110, a determination unit 115, an open license selection unit 120, a license analysis unit 130, a license registration unit 140, a DRM authority generation unit 150, a unique identifier generation unit 160, a unique identifier insertion unit 170, a DRM processing unit 180, a database 190, and so on. The content protection unit 100 may be implemented based on at least one computer terminal. The detailed function of each of the elements and the interworking operation among the elements will be cleared by the description of the operation flow of the content protection system 1 that will be described below.

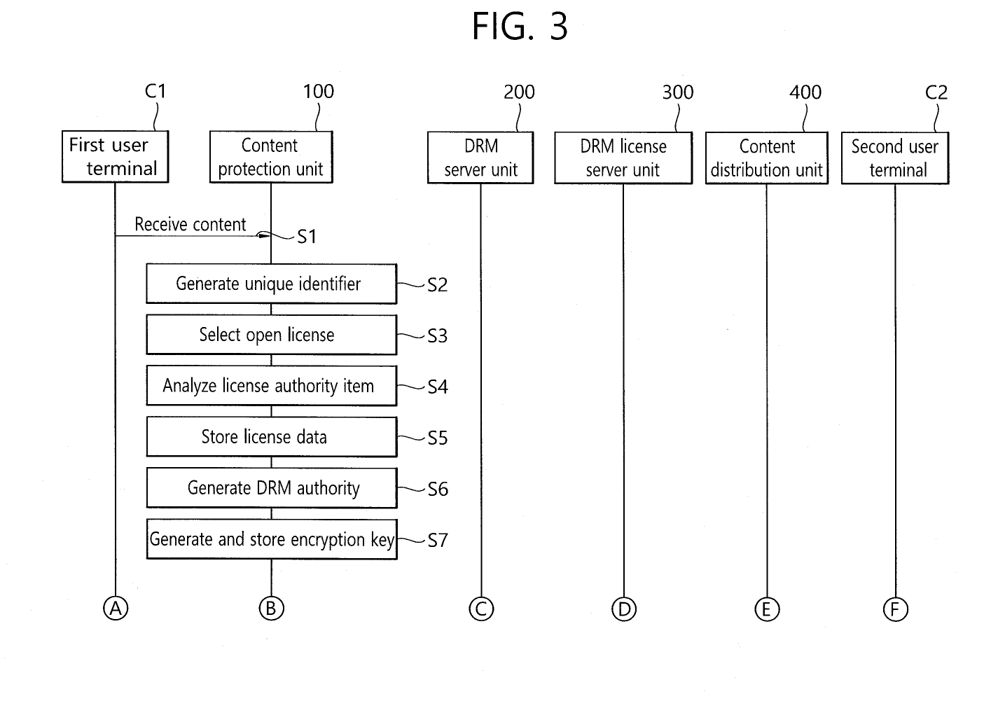

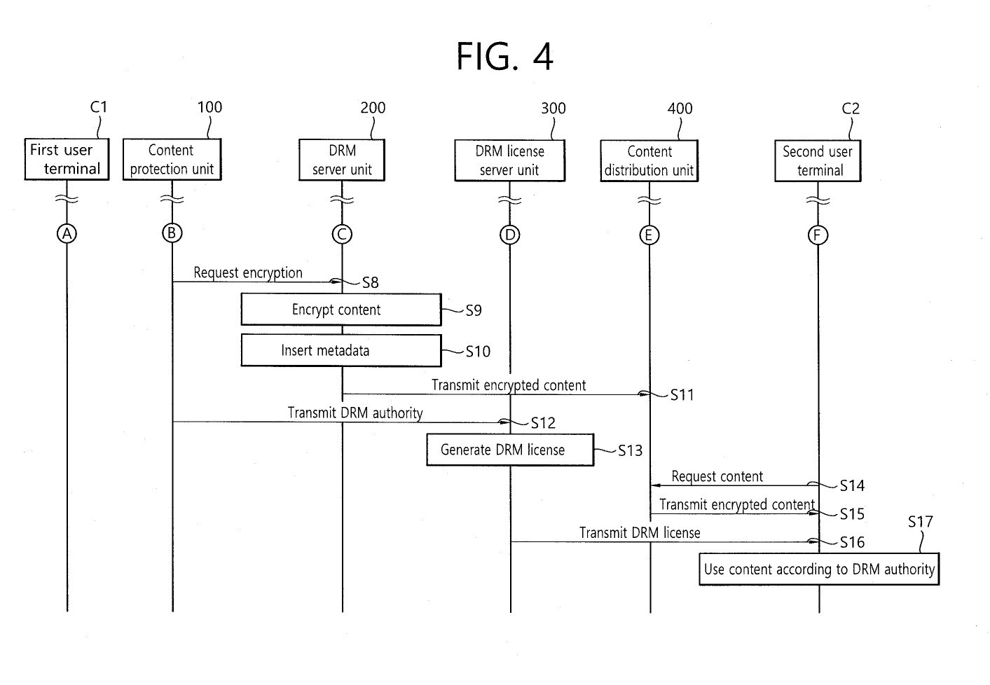

FIGS. 3 and 4 are flowcharts for description the entire operation flow of the content protection system 1. FIGS. 3 and 4 show continuous operations, but are divided for the convenience of description.

Referring to FIG. 1 to FIG. 4, a first user is going to register the content created by the first user or the content modified by the first user in the content protection system 1 based on an open license, and to be protected as a copyright. In the case that the first user registers the created content to the content protection system 1 firstly, the content is referred to as a primary content as a newly registered content, and in the case that the first user is to register the content modified by the first user after modifying the content created by other person, the content is re-registered content referred to as a secondary content. That is, the secondary content may mean a modification content modified by the content that has a history of being registered at least once.

In this embodiment, it is assumed that the content that the first user is going to register is the new content, that is, the primary content, and is a 3D drawing among the various content forms. However, this is just an example, but not limited.

First, the first user accesses the content protection unit 100 using the first user terminal C1 in order to register a 3D drawing created by the first user in the content protection system 1, and the content protection unit 100 receives the content from the first user terminal C1 (step, S1). Such a reception of the content may be performed by the reception unit 110.

The determination unit 115 of the content protection unit 100 determines whether a unique identifier is detected from the received content. The content protection unit 100 gives a unique identifier to the registered content. Accordingly, the content that does not have a history of being registered, that is, the primary content does not have a unique identifier, and the content that has a history of being registered at least once already has a unique identifier. As described above, in this embodiment, since the content received from the first user terminal C1 is the primary content, there is not unique identifier. Accordingly, the content protection unit 100 may determine that a unique identifier of the received content is not existed. Then, the unique identifier generation unit 160 of the content protection unit 100 may generate a unique identifier that corresponds to the content (step, S2).

Next, the open license generation unit of the content protection unit 100 selects an open license that corresponds to the content (step, S3). The open license may be designated by the first user terminal C1, and the open license generation unit may select the designated open license.

For example, the open license generation unit may display the open license selecting user interface that displays the open license applicable to the content on the first user terminal C1. Then, the first user terminal C1 may designate the open license that the first user wants to be protected among the open licenses displayed through the open license selecting user interface. Then, the open license generation unit may select the designated open license.

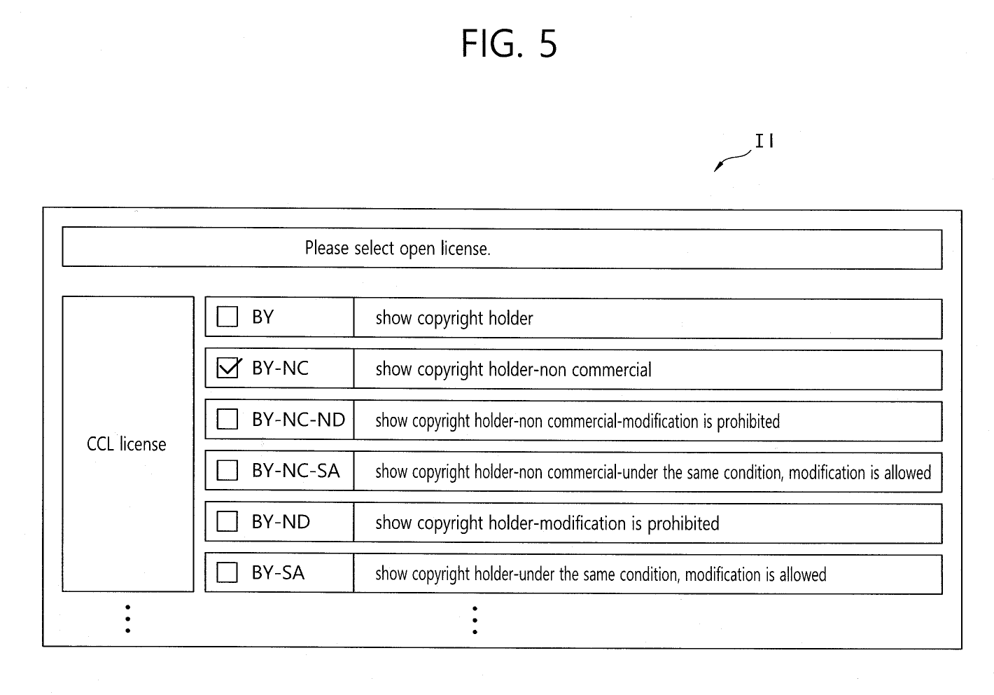

FIG. 5 is an exemplary diagram illustrating an open license selecting user interface displayed on the first user terminal C1 by the open license generation unit.

As shown in FIG. 5, an open license selecting user interface 11 displays a plurality of open licenses. For example, the open license selecting user interface 11 may display BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), BY-SA (show copyright holder-under the same condition, modification is allowed), and so on, as a Creative Common License (CCL). The first user terminal C1 may designate one of the displayed open licenses. For example, in the example shown in FIG. 5, the first user designates BY-NC (show copyright holder-non commercial) using a check box. In this case, the open license selection unit 120 may select the BY-NC (show copyright holder-non commercial) as the open license that is going to be applied to the designated content.

In a preferred embodiment of the present invention, the selectable open license may include PDD (Public Domain Dedication), GPL (General Public License), LGPL (Lesser General Public License), BSD (Berkeley Software Distribution) license, Apache license, AGPL (Affero General Public License), MIT license, Artistic license, MPL (Mozilla Public License), and so on, as well as the CCL such as BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), BY-SA (show copyright holder-under the same condition, modification is allowed), and so on.

When the open license corresponding to the content is selected, the license analysis unit 130 may analyze a license authority item of the selected open license (step, S4). In the present invention, the authorities for protecting a copyright included in various open licenses is classified by a unit authority, and referred to as a license authority item. For example, the license authority item includes a first license authority item representing whether an author of content is displayed, a second license authority item representing whether content is commercially used and re-registration is prohibited, a third license authority item representing whether the content is a secondary work, editing and saving are prohibited, a fourth license authority item representing whether license condition change is prohibited, and so on. Each license item may have values of at least 2. For example, each license item may be configured as “O(Yes)”/“X(No)”, “positive”/“negative”, “True”/“False”, “00”/“01”/“10”/“11”, and the like.

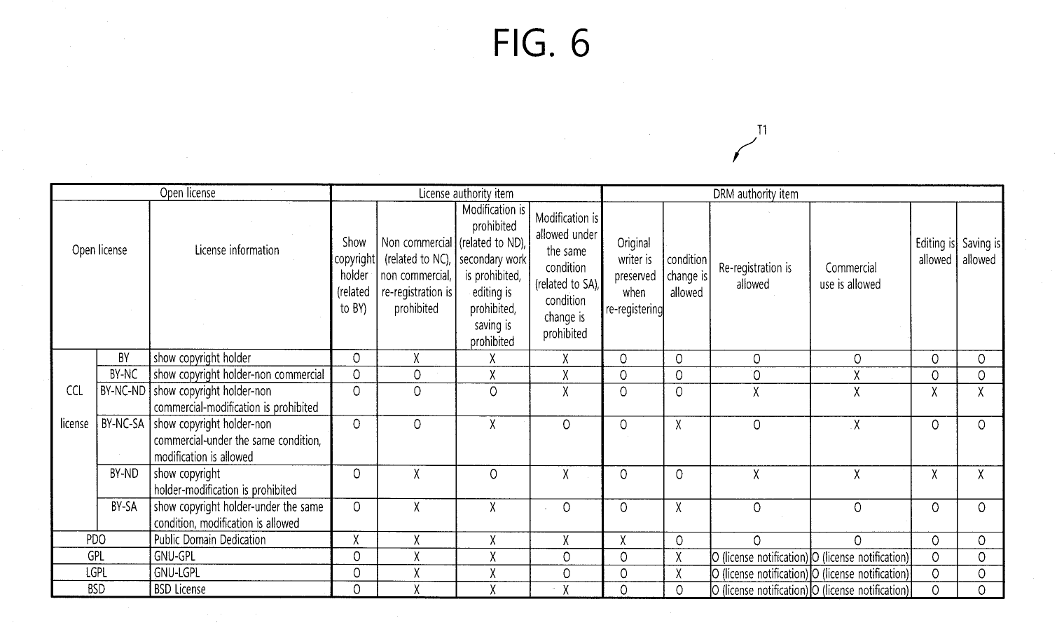

FIG. 6 is an exemplary diagram illustrating an authority analysis table representing values of a license authority item and a DRM authority item that corresponds to an open license.

As shown in FIG. 6, an authority analysis table T1 includes the CCL such as BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), BY-SA (show copyright holder-under the same condition, modification is allowed), and so on, the values of four license authority items that corresponds to the open license such as DD (Public Domain Dedication), GPL (General Public License), LGPL (Lesser General Public License), BSD (Berkeley Software Distribution), and so on, and five values of the DRM authority items.

The four license authority items may include the first license authority item representing whether an author of content is displayed, the second license authority item representing whether content is commercially used and re-registration is prohibited, the third license authority item representing whether the content is a secondary work, editing and saving are prohibited, and the fourth license authority item representing whether license condition change is prohibited. Each of the license authority items may have “O” which is “Yes” value or “X” which is “No” value.

The five values of the DRM authority items may include a first DRM authority item representing whether the information of the author of the content is preserved when re-registering, a second DRM authority item representing whether the license condition change is allowed, a third DRM authority item representing whether the re-registration of the content is allowed, a fourth DRM authority item representing whether the commercial use of the content is allowed, a fifth DRM authority item representing whether the editing of the content is allowed, and a sixth DRM authority item representing whether the content is able to be saved. Each of the DRM authority item may have “O” which is “Yes” value or “X” which is “No” value.

The license authority items, the DRM authority items and the values in the example shown in FIG. 6 are just an example, but it is understood that the content and the number of the license authority items and the DRM authority items corresponding to an open license may be variously configured according to an embodiment environment. That is, the embodiment shown in FIG. 6 shows an exemplary embodiment that gives “O” or “X” value by classifying the open licenses into four license authority items and five DRM authority items among the various embodiments that are implementable.

For example, assuming that the case of using the authority analysis table T1 and the open license selected above is BY-NC, by analyzing the selected open license, the license analysis unit 130 may output the analysis result of the license authority times that the first license authority item representing whether an author of content is displayed is “O” representing that the copyright of the content is displayed, the second license authority item representing whether content is commercially used and re-registration is prohibited is “O” representing that it is prohibited, the third license authority item representing whether the content is a secondary work, editing and saving are prohibited is “X” representing that the secondary work, editing and saving are available, the fourth license authority item representing whether license condition change is prohibited is “X” representing that the license condition change is allowed.

The license registration unit 140 of the content protection unit 100 connects the license data including the information of a plurality of license authority items analyzed by the license analysis unit 130 with the content and the unique identifier of the content, and store it in the database 190 (step, S5). In the database 190, the DRM authority generated by the DRM authority generation unit 150 for encrypting the content together with the information mentioned above, the encryption key generated by the DRM processing unit 180, and so on may be stored with being in relation to the unique identifier of the content. As such, as the unique identifier linked to the content, license data, encryption key, DRM authority, and the like are stored in the database 190, the content is registered in the content protection system 1.

Meanwhile, the DRM authority generation unit 150 of the content protection unit 100 may generate a DRM authority that corresponds to the open license selected based on the license data. That is, the DRM authority generation unit 150 performs the license matching that transforms the value of a plurality of license authority items obtained by analyzing the open licenses to a DRM policy for the content protection.

For example, the DRM authority generation unit 150 may configure the value of a plurality of DRM authority items for controlling the use of the content based on a plurality of license authority items. In this embodiment, as described above, a plurality of DRM authority items may include the first DRM authority item representing whether the information of the author of the content is preserved when re-registering, the second DRM authority item representing whether the license condition change is allowed, the third DRM authority item representing whether the re-registration of the content is allowed, the fourth DRM authority item representing whether the commercial use of the content is allowed, the fifth DRM authority item representing whether the editing of the content is allowed, and the sixth DRM authority item representing whether the content is able to be saved. The DRM authority generation unit 150 may the authority analysis table T1 described above for generating the DRM authority.

For example, assuming that the DRM authority generation unit 150 uses the authority analysis table T1 shown in FIG. 6, the open license selected above is BY-NC, the first license authority item representing whether an author of content is displayed is “O” representing that the copyright of the content is displayed, the second license authority item representing whether content is commercially used and re-registration is prohibited is “O” representing that it is prohibited, the third license authority item representing whether the content is a secondary work, editing and saving are prohibited is “X” representing that the secondary work, editing and saving are available, and the fourth license authority item representing whether license condition change is prohibited is “X” representing that the license condition change is allowed, the result values of the DRM authority items such as first DRM authority item representing whether the information of the author of the content is preserved when re-registering is “O” representing that it is preserved, the second DRM authority item representing whether the license condition change is allowed is “O” representing that it is allowed, the third DRM authority item representing whether the re-registration of the content is allowed is “O” representing that it is allowed, the fourth DRM authority item representing whether the commercial use of the content is allowed is “X” representing that it is not allowed, the fifth DRM authority item representing whether the editing of the content is allowed is “O” representing that it is allowed, and the sixth DRM authority item representing whether the content is able to be saved is “O” representing that it is available.

The values of the license authority items and the DRM authority items of the CCLs which is the open license of the authority analysis table T1 exemplified by referring to FIG. 6 will be described in detail as follows. As described above, “O” shown in the authority analysis table T1 is the value meaning “Yes” and “X” is the value meaning “No”.

In the authority analysis table T1, the first license authority item is “O”, the second license authority item is “X”, the third license authority item is “X”, the fourth license authority item is “X”, the first DRM authority item is “O”, the second DRM authority item is “O”, the third DRM authority item is “O”, the fourth DRM authority item is “O”, the fifth DRM authority item is “O”, and the sixth DRM authority item is “O” of BY (show copyright holder) which is an open license.

In the authority analysis table T1, the first license authority item is “O”, the second license authority item is “O”, the third license authority item is “X”, the fourth license authority item is “X”, the first DRM authority item is “O”, the second DRM authority item is “O”, the third DRM authority item is “O”, the fourth DRM authority item is “X”, the fifth DRM authority item is “O”, and the sixth DRM authority item is “O” of BY-NC (show copyright holder-non commercial) which is an open license.

In the case of the BY-NC, since the second license authority item representing whether content is commercially used and re-registration is prohibited is “O” representing that it is prohibited but the third license authority item representing whether the content is a secondary work, editing and saving are prohibited is “X” representing that the secondary work, editing and saving are available, the third DRM authority item representing whether the re-registration of the content is allowed is “O” representing that it is allowed and the fourth DRM authority item representing whether the commercial use of the content is allowed is “X” representing that it is not allowed. As such, the authority analysis table T1 determines the values such that the four license authority items are easily matched to the six DRM authority items.

In the authority analysis table T1, the first license authority item is “O”, the second license authority item is “O”, the third license authority item is “O”, the fourth license authority item is “X”, the first DRM authority item is “O”, the second DRM authority item is “O”, the third DRM authority item is “X”, the fourth DRM authority item is “X”, the fifth DRM authority item is “X”, and the sixth DRM authority item is “X” of BY-NC-ND (show copyright holder-non commercial-modification is prohibited) which is an open license.

In the authority analysis table T1, the first license authority item is “O”, the second license authority item is “O”, the third license authority item is “X”, the fourth license authority item is “O”, the first DRM authority item is “O”, the second DRM authority item is “X”, the third DRM authority item is “O”, the fourth DRM authority item is “X”, the fifth DRM authority item is “O”, and the sixth DRM authority item is “O” of BY-NC-SA (show copyright holder-non commercial-under the same condition, modification is allowed) which is an open license.

In the authority analysis table T1, the first license authority item is “O”, the second license authority item is “X”, the third license authority item is “O”, the fourth license authority item is “X”, the first DRM authority item is “O”, the second DRM authority item is “O”, the third DRM authority item is “X”, the fourth DRM authority item is “X”, the fifth DRM authority item is “X”, and the sixth DRM authority item is “X” of BY-ND (show copyright holder-modification is prohibited) which is an open license.

In the authority analysis table T1, the first license authority item is “O”, the second license authority item is “X”, the third license authority item is “X”, the fourth license authority item is “O”, the first DRM authority item is “O”, the second DRM authority item is “X”, the third DRM authority item is “O”, the fourth DRM authority item is “O”, the fifth DRM authority item is “O”, and the sixth DRM authority item is “O” of BY-SA (show copyright holder-under the same condition, modification is allowed) which is an open license.

As shown in FIG. 6, the authority analysis table T1 defines the values of the license authority items and the DRM authority items of PDD, GPL, LGPL, BSD, and the like as well as the CCL.

Meanwhile, the DRM processing unit 180 may generate the encryption key for encrypting the content, and may store the generated encryption key in the database 190 with being connected to the unique identifier of the content (step, S7). The encryption key may be an encryption random key, for example. The DRM processing unit 180 may also store the DRM authority with being connected to the unique identifier.

The DRM processing unit 180 may request to encrypt the content based on the generated DRM authority to the DRM server unit 200 (step, S8). For example, the DRM processing unit 180 may transmit a content encryption request message that includes the content, the unique identifier of the content, the DRM authority, the encryption key, and so on to the DRM server unit 200.

The DRM server unit 200 that receives the content encryption request message encrypts the content based on the encryption key and the DRM authority (step, S9). The DRM server unit 200 may generate metadata based on the information included in the content encryption request message transmitted from the DRM processing unit 180 of the content protection unit 100, and may link the generated metadata with the encrypted content (step, S10). The DRM server unit 200 may transmit the encrypted content to the content distribution unit 400 (step, S11).

Meanwhile, the unique identifier insertion unit 170 may insert the unique identifier of the content generated by the unique identifier generation unit 160 in the content in a form of a watermark or in the metadata of the content. In this embodiment, the case is described that the unique identifier insertion unit 170 is included in the content protection unit 100, but the unique identifier insertion unit 170 may be provided in the DRM server unit 200, or the function of the unique identifier insertion unit 170 may be provided in the content protection unit 100 and the DRM server unit 200 in distributed manner.

Meanwhile, the DRM processing unit 180 may transmit the DRM authority and the encryption key to the DRM license server unit 300 (step, S12). The DRM license server unit 300 generates a DRM license based on the DRM authority and the encryption key transferred from the DRM processing unit 180 (step, S13). The generated DRM license is linked with the encrypted content which is distributed by the content distribution unit 400. That is, the use of the encrypted content is limited within the range allowed by the DRM license.

For example, the second user accesses to the content distribution unit 400 using the second user terminal C2 and identifies the content generated by the first user above and registered in the content protection system 1, and wants to use the content. Accordingly, the second user terminal C2 may request the content to the content distribution unit 400 (step, S14). Then, the content distribution unit 400 transmits the requested content to the second user terminal C2 (step, S15).

Since the content is the encrypted content and available to be used within the DRM authority range included in the DRM license, the second user terminal C2 receives the DRM license from the DRM license server unit 300 (step, S16). Then, the second user terminal C2 may use the content according to the DRM authority allowed by the DRM license. The second user terminal C2 may be provided with a DRM module for limiting the use of the content according to the DRM license.

As described above, according to a preferred embodiment of the present invention, only by the process that the copyright holder of the content accesses to the content protection unit 100 through a user terminal and selects an open license to be protected for the copyright holder's content, the copyright may be protected strictly and reliably based on the DRM applied to the content.

Meanwhile, in the embodiment above, it is exemplified that the content received from the first user terminal C1 is the primary content which is a newly registered content, but the content received from the first user terminal C1 may also be the secondary content that has a history of being registered in the content protection system 1 at least once as well as the primary content. For example, after a user receives the content already registered in the content protection system 1 from the content distribution unit 400 and modifies it, the user may be intended to protect the modified content, that is, the secondary content.

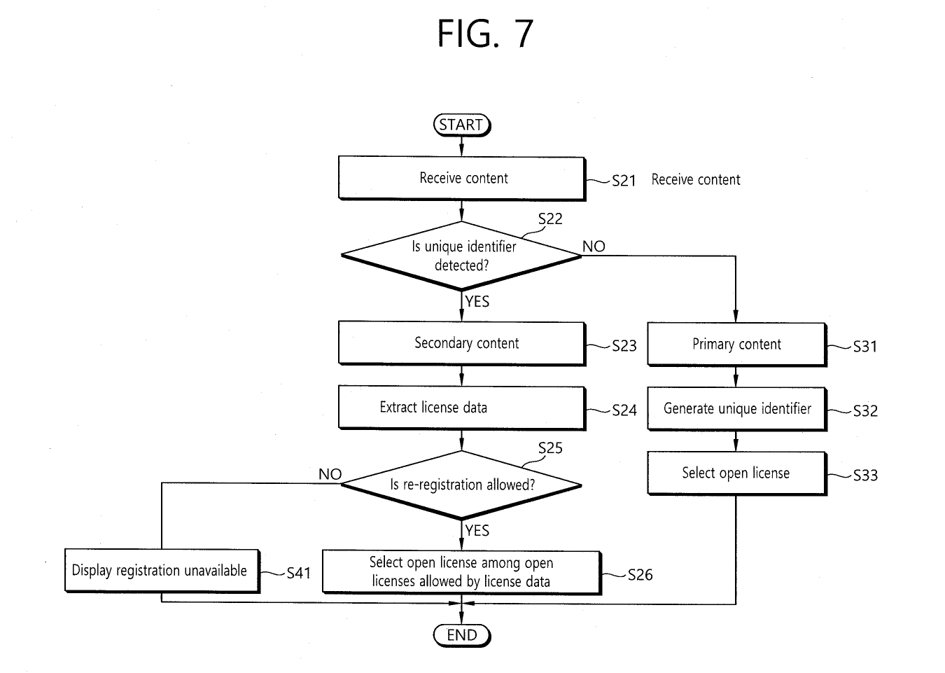

Hereinafter, an embodiment will be described for mainly describing the operation of the content protection unit 100 when a secondary content is received from the first user terminal C1. FIG. 7 is a flowchart for describing a part of operation of the content protection unit 100 mainly in the case that a secondary content is received from the first user terminal C1.

As shown in FIG. 7, first, the content protection unit 100 receives content from the first user terminal C1 (step, S21). The determination unit 115 of the content protection unit 100 determines whether a unique identifier is detected from the received content (step, S22).

Herein, in the case that a unique identifier of the content is not detected, the content protection unit 100 may determine the content to be a primary content which is newly registered (step, S31), and perform the generation of a unique identifier (step, S32) and the selection of an open license (step, S33) as the same as step S2 and step S3 described above.

On the contrary, in the case that a unique identifier of the content is detected from the received content, the determination unit 115 of the content protection unit 100 determines the content to be a re-registered content that has a history of being registered, that is, a secondary content (step, S23), and extracts license data that corresponds to the detected unique identifier from the database 190 (step, S24).

When the license data is extracted, the determination unit 115 of the content protection unit 100 may analyze the license data and determine whether the content is content available to be re-registered (step, S25). For example, when the third license authority item included in the license data extracted from the database 190, that is, the license authority item representing whether the content is a secondary work, editing and saving are prohibited is a value (e.g., “O”) representing that the secondary work, editing and saving are unavailable, the determination unit 115 may determine that the content is unavailable to be re-registered. In this case, the content protection unit 100 may display registration unavailable message representing registration unavailable on the first user terminal C1 (step, S41).

On the contrary, when the third license authority item of the license data extracted from the database 190 is a value (e.g., “X”) representing that the secondary work, editing and saving are available, the content protection unit 100 may determine that the content is available to be registered. In this case, the open license selection unit 120 of the content protection unit 100 selects an open license among the open licenses allowed by the extracted license data only among the entire open licenses (step, S26).

For example, the open license generation unit may determine the open licenses allowed by the license data among the entire open licenses, and may display the open license selecting user interface such that a user is available to select the determined open licenses only. For example, the open license generation unit may provide the open license selecting user interface in such a way that the open license generation unit may not display an unallowable open license on the open license selecting user interface, may display the unallowable open license by being inactivated such that the unallowable state is identified, or the unallowable open license is available to be displayed and selected but an error message is popping up.

Accordingly, according to the embodiment, the open license of the content which is re-registered is available only within the range which is allowed by the license data (i.e., the license data linked with the content before modification) that corresponds to the open license selected by the copyright holder that registered the content before.

Of course, in the case that, among the license data connected with the content before modification, the fourth license authority item representing whether license condition change is prohibited is a value representing that the license condition change is allowed, a first user may select one of the open licenses without restriction when registering the content. This is because such a case may correspond that the copyright holder, who registered content before, allows a person who is going to change the license later to register the content by modifying a license condition.

When the open license that corresponds to the content is selected by step S26 or step S33, the content protection system 1 may perform step S4 to step S17 described above.

As such, according to the present invention, since the license data and the DRM application are performed based on an open license, the re-registration of content may be established within the range permitted by the previous copyright holder. Accordingly, strict protection of the copyright may be realized according to the intention of the copyright holder. In addition, except the PDD, since almost all open licenses are determined to show a copyright holder, for the content registered with being modified many times, the information of the copyright holders that register the content with modification is preserved in every time, and consequently, traceability for modification becomes easier.

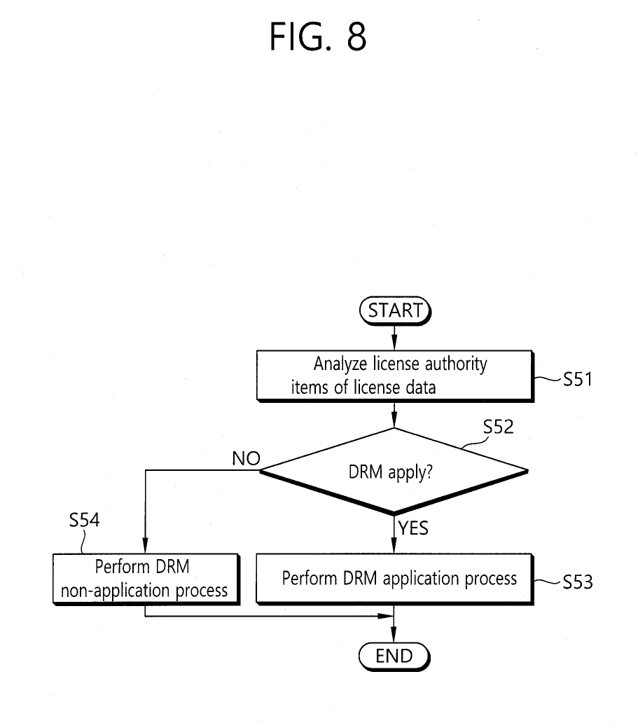

FIG. 8 is a flowchart for describing the embodiment of selectively performing DRM application to the content registered according to a selected open license as another embodiment of the present invention.

After step S4 described above is performed, as shown in FIG. 8, the content protection unit 100 may analyze the license authority items corresponding to the open license of the content that is going to be registered (step, S51).

The content protection unit 100 may determine whether to apply the DRM to the content based on the analysis result (step, S52). For example, the content protection unit 100 may correspond a store to the value of each of the license authority items, and may not apply the DRM to the content when the value calculating the scores (e.g., adding up) is a reference score or below (or above), and may apply the DRM to the content for other cases.

For example, assuming that the store is 2 when the value of the first license authority item is “O” and the score is 0 when the value of the first license authority item is “X”, the store is 2 when the value of the second license authority item is “O” and the score is 0 when the value of the second license authority item is “X”, the store is 2 when the value of the third license authority item is “O” and the score is 0 when the value of the third license authority item is “X”, and the store is 2 when the value of the fourth license authority item is “O” and the score is 0 when the value of the fourth license authority item is “X”, the DRM is not applied when total score is 2 or below and the DRM is applied otherwise (i.e., total score exceeds 2).

In such a case, in the case that the selected open license is BY (show copyright holder), the score of the first license authority item is 2, the score of the second license authority item is 0, the score of the third license authority item is 0, and the score of the fourth license authority item is 0. Accordingly, in this case, the content protection unit 100 may determine not to apply the DRM to the content.

When determining not to apply the DRM, the content protection unit 100 may perform a DRM non-application process (step, S54). For example, the content protection unit 100 may insert a unique identifier of the content to the content in a form of watermark or include a unique identifier in the metadata. In addition, the content protection unit 100 may register the content in the content protection system 1 by storing the content, the unique identifier of the content, the license data, and the like in the database 190.

On the contrary, when determining to apply the DRM, the content protection unit 100 may perform the DRM application process (step, S53). The DRM application process has been described in detail based on step S6 to step S17 in the description with reference to FIG. 3 and FIG. 4 above.

So far, the present invention has been described with reference to the drawings and the embodiments, which does not mean the scope of the present invention is not limited thereto, and it should be understood by those skilled in the art, however, that the present invention can be modified or changed in various ways without departing from the technical principles and scope.

As described above, according to the present invention, the right of the content copyright holder may be protected reliably, by controlling the use authority of the content based on an open license selected by the content copyright holder.

What is claimed is:

1. A method for protecting content based on an open license performed by a content protection apparatus, comprising:
receiving content from a user terminal;
selecting an open license corresponding to the received content;
analyzing a plurality of license authority items corresponding to the selected open license;
storing license data including a value of the plurality of license authority items which is analyzed in a database with being linked with a unique identifier of the content;
generating a Digital Rights Management (DRM) authority matched to the open license based on the value of the plurality of license authority items which is analyzed; and
requesting to encrypt the content based on the generated DRM authority to a DRM server.

2. The method for protecting content based on an open license of claim 1, wherein selecting the open license includes:
displaying an open license selecting user interface displaying open licenses applicable to the content on the user terminal; and
selecting the open license designated by the user terminal through the open license selecting user interface.

3. The method for protecting content based on an open license of claim 1, further comprising:
determining whether the received unique identifier of the content is detected from the content or metadata of the content;
determining the content to be a primary content which is newly registered content, when a unique identifier of the content is not detected; and
determining the content to be a secondary content which is re-registered content that has a history of being registered at least once, when the unique identifier of the content is detected.

4. The method for protecting content based on an open license of claim 3, when the content is the secondary registered content, further comprising:
extracting pre-stored license data corresponding to the unique identifier of the content from the database before selecting the open license,
wherein selecting the open license includes selecting the open license among open licenses permitted by the extracted license data.

5. The method for protecting content based on an open license of claim 3, when the content is the primary registered content, further comprising:
generating a unique identifier of the content; and
inserting the unique identifier of the content in the content in a form of watermark or in the metadata of the content.

6. The method for protecting content based on an open license of claim 1, further comprising:
generating an encryption key for encrypting the content; and
storing the encryption key in the database,
wherein requesting to encrypt the content to the DRM server includes requesting the generated encryption key and an encryption request message including the DRM authority to the DRM server.

7. The method for protecting content based on an open license of claim 1, wherein the open license is a Creative Common License (CCL), and
wherein the open license is one of BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), and BY-SA (show copyright holder-under the same condition, modification is allowed).

8. The method for protecting content based on an open license of claim 1, wherein the open license is one of PDD (Public Domain Dedication), GPL (General Public License), LGPL (Lesser General Public License), BSD (Berkeley Software Distribution) license, Apache license, AGPL (Affero General Public License), MIT license, Artistic license, and MPL (Mozilla Public License).

9. The method for protecting content based on an open license of claim 1, wherein the plurality of license authority items includes:
a first license authority item representing whether an author of content is displayed;
a second license authority item representing whether content is commercially used and re-registration is prohibited;
a third license authority item representing whether the content is a secondary work, editing and saving are prohibited; and
a fourth license authority item representing whether license condition change is prohibited.

10. The method for protecting content based on an open license of claim 1, wherein generating the DRM authority matched to the open license includes configuring a value of a plurality of DRM authority items for controlling a use of the content based on the plurality of license authority items, and
wherein the plurality of DRM authority items includes:
a first DRM authority item representing whether the information of the author of the content is preserved when re-registering;
a second DRM authority item representing whether the license condition change is allowed;
a third DRM authority item representing whether the re-registration of the content is allowed;
a fourth DRM authority item representing whether the commercial use of the content is allowed;
a fifth DRM authority item representing whether the editing of the content is allowed; and
a sixth DRM authority item representing whether the content is able to be saved.

11. An apparatus for protecting content based on an open license, comprising:
a receiver configured to receive content from a user terminal;
an open license selection unit configured to select an open license corresponding to the received content;
a license analysis unit configured to analyze a plurality of license authority items corresponding to the selected open license;
a license registration unit configured to store license data including a value of the plurality of license authority items which is analyzed in a database with being linked with a unique identifier of the content;
a DRM authority generation unit configured to generate a Digital Rights Management (DRM) authority matched to the open license based on the value of the plurality of license authority items which is analyzed; and
a DRM processing unit configured to request to encrypt the content based on the generated DRM authority to a DRM server.

12. The apparatus for protecting content based on an open license of claim 11, wherein the open license selection unit displays an open license selecting user interface displaying open licenses applicable to the content on the user terminal, and selects the open license designated by the user terminal through the open license selecting user interface.

13. The apparatus for protecting content based on an open license of claim 11, further comprising a determination unit configured to determine whether the received unique identifier of the content is detected from the content or metadata of the content, determine the content to be a primary content which is newly registered content, when a unique identifier of the content is not detected, and determine the content to be a secondary content which is re-registered content that has a history of being registered at least once, when the unique identifier of the content is detected.

14. The apparatus for protecting content based on an open license of claim 13, when the content is the secondary registered content,
wherein the open license selection unit extracts pre-stored license data corresponding to the unique identifier of the content from the database before selecting the open license, and selects the open license among open licenses permitted by the extracted license data.

15. The apparatus for protecting content based on an open license of claim 13, when the content is the primary registered content, further comprising:
a unique identifier generation unit configured to generate a unique identifier of the content; and
a unique identifier insertion unit configured to insert the unique identifier of the content in the content in a form of watermark or in the metadata of the content.

16. The apparatus for protecting content based on an open license of claim 11, wherein the DRM processing unit generates an encryption key for encrypting the content, stores the encryption key in the database, and requests the generated encryption key and an encryption request message including the DRM authority to the DRM server.

17. The apparatus for protecting content based on an open license of claim 11, wherein the open license is a Creative Common License (CCL), and
wherein the open license is one of BY (show copyright holder), BY-NC (show copyright holder-non commercial), BY-NC-ND (show copyright holder-non commercial-modification is prohibited), BY-NC-SA (show copyright holder-non commercial-under the same condition, modification is allowed), BY-ND (show copyright holder-modification is prohibited), and BY-SA (show copyright holder-under the same condition, modification is allowed).

18. The apparatus for protecting content based on an open license of claim 11, wherein the open license is one of PDD (Public Domain Dedication), GPL (General Public License), LGPL (Lesser General Public License), BSD (Berkeley Software Distribution) license, Apache license, AGPL (Affero General Public License), MIT license, Artistic license, and MPL (Mozilla Public License).

19. A system for protecting content, comprising:
a content protection unit configured to receive content from a first user terminal, select an open license corresponding to the received content, analyze a plurality of license authority items corresponding to the selected open license, store license data including a value of the plurality of license authority items which is analyzed in a database with being linked with a unique identifier of the content, and generate a Digital Rights Management (DRM) authority matched to the open license based on the value of the plurality of license authority items which is analyzed;
a DRM server unit configured to encrypt the content based on the DRM authority and transmit the content to a content distribution unit; and
a DRM license server unit configured to receive the DRM authority from the content protection unit, and generate a DRM license for a use of the content encrypted based on the DRM authority.

20. A method for protecting content performed by a content protection apparatus, comprising:
receiving content from a user terminal;
selecting an open license corresponding to the received content;
analyzing a plurality of license authority items corresponding to the selected open license;
storing license data including a value of the plurality of license authority items which is analyzed in a database with being linked with a unique identifier of the content;
determining whether to apply a Digital Rights Management (DRM) to the content based on the license data; and
performing one of a DRM non-application process that does not apply the DRM to the content and a DRM application process that applies the DRM to the content, based on the determination.
